(19) United States
(12) Patent Application Publication
(10) Pub. No.: US 2020/0324373 A1
(43) Pub. Date: Oct. 15, 2020

(54) IRON-BASED AMORPHOUS NANOCRYSTALLINE LASER CLADDING COMPOSITE COATING, PREPARATION METHOD AND TEST METHOD THEREOF

(71) Applicants: Baolong Shen, Nanjing (CN); Xudong Bai, Nanjing (CN); Qianqian Wang, Nanjing (CN)

(72) Inventors: Baolong Shen, Nanjing (CN); Xudong Bai, Nanjing (CN); Qianqian Wang, Nanjing (CN)

(21) Appl. No.: 16/848,805

(22) Filed: Apr. 14, 2020

(30) Foreign Application Priority Data
Apr. 15, 2019 (CN) 201910298201.7

(51) Int. Cl. B23K 26/34; C23C 24/10; B23K 26/60; G01N 3/08; C22C 45/02

(52) U.S. Cl. CPC B23K 26/34; C23C 24/106; B82Y 30/00; G01N 3/08; C22C 45/02; B23K 26/60

(57) ABSTRACT

The invention discloses an iron-based amorphous nanocrystalline laser cladding composite coating and preparation and test methods thereof; the composition of the cladding composite coating meets the molecular formula: FeaCobNicBdSiyNbe, wherein a, b, c, d, y, and e respectively represent the atomic percentage of the corresponding alloy element; a plus b plus c plus d plus y plus e equals 100; the preparation method is: weighing the raw materials and mixing to obtain the alloy powder, substrate pretreatment, tiling the alloy powder on the surface of the substrate, the laser beam is scanned vertically to perform laser cladding on the alloy powder. The composite has a certain amorphous content, high microhardness, excellent wear resistance, and outstanding fracture strength. The preparation process is simple, the raw materials do not contain rare earths or volatile elements, and the application prospect is broad.

### BACKGROUND OF THE INVENTION

### 1. Field of the Invention

The invention relates to an iron-based amorphous nanocrystalline laser cladding composite coating and preparation and test methods thereof, belonging to the technical field of laser cladding composite novel materials.

### 2. Description of the Related Art

Laser cladding is a novel type of surface modification technology. Obtaining an amorphous cladding coating on the surface of traditional materials can improve surface hardness, corrosion resistance and wear resistance, whose cost is low, so it has great potential application value. The laser cladding method can enhance the surface strength and hardness of the device without affecting the strength and toughness of the base material, thereby greatly improving the overall comprehensive performance and service life of the material. In the field of heavy industry, laser cladding technology is an important means for repairing and strengthening parts, and has obvious economic benefits.

The laser cladding coating has the characteristics of high bonding strength to the substrate and small heat affected zone, but spraying alloy powder is used or bulk amorphous alloy composition is prepare for most of the commonly used laser cladding powders; in order to ensure the amorphous forming ability, the Fe-based bulk amorphous alloy composition contains Si and B elements. In the process of laser cladding, high-temperature effects will cause the easy-to-oxidize elemental elements such as Si and B elements to burn out; since it is difficult to achieve vacuum condition in industrial applications, the remaining metal elements will be oxidized to reduce the amorphous volume content and performance of the cladding coating. In addition, most researchers use smelting alloys and atomization methods to prepare cladding-coated metal powders, which complicates the process flow and increases the preparation costs.

Chinese patent CN106868496A discloses a method for preparing Fe-based amorphous coating, and the alloy composition is: 17.3 to 19.4% of Cr element; 1.8 to 2.2% of Mn element; 12.9 to 15.8% of Mo element; 5.0 to 6.2% of W element; 2.8 to 4.1% of B element; 0.7 to 1.1% of C element; 1.0 to 1.5% of Si element; the rest is Fe with a hardness of 980 to 1180 HV; however, its cladding powder uses industrial purity raw materials and tightly coupled gas atomization technology to prepare the iron-based amorphous alloy of this composition into powder raw materials, which increases the difficulty of preparation and limits the scope of application.

Chinese patent CN107620062A discloses a method for preparing crack-resistant and corrosion-resistant cladding layer, whose composition is: 30 at. % of Cobalt, 26 at. % of Chromium, 25 at. % of Iron, 8 at. % of Nickel, 7 at. % of Silicon, and 4 at. % of boron; its hardness is up to 600 HV_{0.2}, the hardness is not outstanding and its thickness is less than 0.5 mm, which limits the development.

### SUMMARY OF THE INVENTION

Technical issues: the objective of the invention is to provide an iron-based amorphous nanocrystalline laser cladding composite coating and preparation and test methods thereof, which fully utilizes the price advantage of Fe-based alloys, reduces the cost of preparing raw material powders, and reduces the dependence on the vacuum environment during the cladding process. The invention adopts a method for adjusting the content of Si element of the cladding composite coating to achieve the effect of slag-forming protective alloy, which solves the problem that the laser cladding iron-based cladding composite coating is susceptible to oxidation in the atmospheric environment. The iron-based amorphous nanocrystalline laser cladding composite coating prepared has high strength and high wear resistance, and has a certain amorphous content, high microhardness, excellent wear resistance, and outstanding fracture strength.

Technical solutions: the invention provides an iron-based amorphous nanocrystalline laser cladding composite coating, wherein the composition of the cladding composite coating meets the molecular formula: FeaCobNicBdSiyNbe, where a, b, c, d, y, and e respectively represent the atomic percentage of the corresponding alloy element; a is greater than or equal to 32 and less than or equal to 44, b is greater than or equal to 10 and less than or equal to 15, c is greater than or equal to 10 and less than or equal to 15, d is greater than or equal to 18 and less than or equal to 20, y is greater than or equal to 4 and less than or equal to 23, e is greater than or equal to 4 and less than or equal to 5, and a plus b plus c plus d plus y plus e equals 100.

Where:

the atomic percentage of Si element in the molecular formula is preferably that y is greater than or equal to 4.8 and less than or equal to 22.08, and a plus b plus c is greater than or equal to 55 and less than or equal to 72.

The structure of the cladding composite coating is an amorphous nanocrystalline composite structure, and the maximum amorphous volume fraction is 12.4% to 40.9%, and the particle size of the nanocrystalline is 17 to 20 nm.

The micro-Vickers hardness of the cladding composite coating is 720 to 1038 HV_{0.1}; the wear resistance is more than 11 times that of the conventional 45# steel, and the breaking strength is 2160 to 2880 MPa.

The invention further provides a preparation method of the iron-based amorphous nanocrystalline laser cladding composite coating, wherein the preparation method comprises the following steps:

step 1: weighing the raw materials according to the atomic percentage in the molecular formula FeaCobNicBdSiyNbe of the cladding composite coating: cobalt iron powder, nickel iron powder, boron iron powder, ferrosilicon powder, ferroniobium powder and pure iron powder, and mixing the raw materials uniformly to obtain the alloy powder;

step 2: polishing the surface of the steel substrate to remove rust and grease to make the surface clean and flat;

step 3: after removing the residual moisture from the alloy powder and the steel substrate, tiling the alloy powder on the surface of the steel substrate;

step 4: adjusting the parameters of the laser cladding process so that the laser beam is scanned vertically; performing the laser cladding on the preset alloy powder to obtain the iron-based amorphous nanocrystalline laser cladding composite coating.

Where:

the raw materials in step 1 are: Fe is the pure iron powder with a content of greater than 99.9 wt %, Co is the cobalt iron powder with a content of greater than 99.9 wt %, Ni is the nickel iron powder with a content of greater than 99.9 wt %, B is the boron iron powder with a content of greater than 19.4 wt %, Si is the ferrosilicon powder with a content of greater than 75 wt %, and Nb is the ferroniobium powder with a content of greater than 70 wt %; the balance in the cobalt iron powder, nickel iron powder, boron iron powder, ferrosilicon powder, ferroniobium powder is Fe, and the particle size of each raw material powder is 100 to 150 μm.

The method of mixing the raw materials in step 1 is to use a ball mill for ball milling and mixing; the ball milling speed is 100 to 120 r/min, and the ball milling time is 10 to 12 hrs; the method of removing the residual moisture from the alloy powder and the steel substrate in step 3 refers to drying the alloy powder in a drying box at a temperature of 80 to 100° C. for 4 to 5 hrs, and placing the steel substrate in the drying box to dry at a temperature of 80 to 100° C. for 30 to 40 mins.

In the method of tiling the alloy powder on the surface of the steel substrate in step 3, the thickness of the alloy powder tiled is 0.9 to 1 mm.

In the method of adjusting the parameters of the laser cladding process in step 4, the specific parameters are a laser power of 2 to 2.5 kW, a laser scanning speed of 5 to 6 mm/s, and a spot size of 14.5×2.5 mm.

In the method of adjusting the parameters of the laser cladding process, the laser is a 3 kW semiconductor laser, and the distance from the laser mirror surface to the surface of the steel substrate is the focal distance of the laser.

In the method of performing the laser cladding on the preset alloy powder, an infrared pre-scan is used to determine an area to be cladding.

A test method of the iron-based amorphous nanocrystalline laser cladding composite coating, wherein the method is used to test the breaking strength of the cladding composite coating, comprising the following steps:

1) separating the iron-based amorphous nanocrystalline laser cladding composite coating from the iron-base, to obtain a sample of the amorphous nanocrystalline laser cladding composite coating;

2) placing the sample vertically on the compression table of a universal testing machine at room temperature, and setting the compression rate;

3) compressing the sample to obtain the stress-strain curve until the sample breaks.

Where:

the sample of the amorphous nanocrystalline laser cladding composite is a rectangular parallelepiped with a length and a width of 0.5 to 1 mm and a height of 1 to 2 mm; the compression rate is 4×10⁻⁴ s⁻¹ to 5×10⁻⁴ s⁻¹.

The iron-based amorphous nanocrystalline laser cladding composite coating provided by the invention is composed of Fe, Co, Ni, B, Si, Nb elements, wherein Fe, Co, Ni elements can ensure that the cladding coating has a higher hardness and a larger fracture strength; B and Si elements can effectively improve the oxidation resistance of the cladding coating and improve the ability to form amorphous materials; excessive Si elements can better react with oxygen during the cladding process to protect the internal metal elements; Nb element can improve the thermal stability of the cladding coating and is beneficial to the formation of amorphous.

Advantageous effects: compared with the prior art, the invention has the following advantageous effects:

1. the preparation process of the iron-based amorphous nanocrystalline laser cladding composite coating provided by the invention does not depend on the vacuum environment;

2. the iron-based amorphous nanocrystalline laser cladding composite coating provided by the invention adjusts the content of Si element in the alloy composition; since the Si element preferentially reacts with oxygen during the cladding process, thereby protecting the metal components in the alloy components from being oxidized and playing a role of deoxidation and slagging, thereby increasing the amorphous content of the Fe-based composite coating; the amorphous volume fraction is 12.4% to 40.9%;

3. the iron-based amorphous nanocrystalline laser cladding composite coating provided by the invention has an excellent mechanical property; with the addition of Si element, on the basis of ensuring that the cladding composite coating has a certain amorphous content, the mechanical property of the cladding composite coating is significantly improved, especially the hardness of the cladding composite coating is increased, and the micro-Vickers hardness is 720 to 1038 HV_{0.1}; at the same time, the wear resistance of the cladding composite coating is improved, which is more than 11 times that of the conventional 45# steel;

4. the invention firstly proposes a test method of the breaking strength of the cladding coating, which provides a new method for testing the mechanical property of the cladding coating; through testing, the iron-based amorphous nanocrystalline laser cladding composite coating provided by the invention has an excellent fracture strength, which is up to 2160 to 2880 MPa, and is more than 10 times that of the conventional low-carbon steel q235 yield strength 2 of 35 MPa.

5. the iron-based amorphous nanocrystalline laser cladding composite coating provided by the invention is prepared by using pure iron powder, cobalt iron powder, nickel iron powder, boron iron powder, ferrosilicon powder, ferroniobium powder; the selection of boron iron powder and ferrosilicon powder on the one hand reduces the cost of selecting pure element alloy powder, and effectively avoids the problem of easy burnout of pure boron and pure silicon under the action of laser; the selection of ferroniobium powder avoids the shortcomings of pure niobium with high melting point and refractory, and at the same time reduces the cost of energy loss, which is consistent with green manufacturing;

6. the iron-based amorphous nanocrystalline laser cladding composite coating provided by the invention has a dense structure, excellent bonding with a substrate, and no defects such as voids and pores; it has a certain amorphous volume fraction, excellent mechanical property and outstanding fracture strength, etc.; in addition, the cost of preparing raw materials is low, the preparation process is simple, a high vacuum environment is not required, and it has a good application prospect, which can be used as a cladding composite coating material in the field of remanufacturing.

### BRIEF DESCRIPTION OF THE DRAWINGS

FIG. 1 is a phase analysis diagram illustrating the iron-based amorphous nanocrystalline laser cladding composite coating ((Fe_{0.6}Co_{0.2}Ni_{0.2})_{0.75-0.03x}B_{0.2}Si_{0.05+0.03x})₉₆Nb₄ of the invention;

FIG. 2 is a hardness diagram illustrating the iron-based amorphous nanocrystalline laser cladding composite coating ((Fe_{0.6}Co_{0.2}Ni_{0.2})_{0.75-0.03x}B_{0.2}Si_{0.05+0.03x})₉₆Nb₄ of the invention;

FIG. 3 is a wear resistance diagram illustrating the iron-based amorphous nanocrystalline laser cladding composite coating ((Fe_{0.6}Co_{0.2}Ni_{0.2})_{0.75-0.03x}B_{0.2}Si_{0.05+0.03x})₉₆Nb₄ of the invention;

FIG. 4 is a breaking strength diagram illustrating the iron-based amorphous nanocrystalline laser cladding composite coating ((Fe_{0.6}Co_{0.2}Ni_{0.2})_{0.75-0.03x}B_{0.2}Si_{0.05+0.03x})₉₆Nb₄ of the invention.

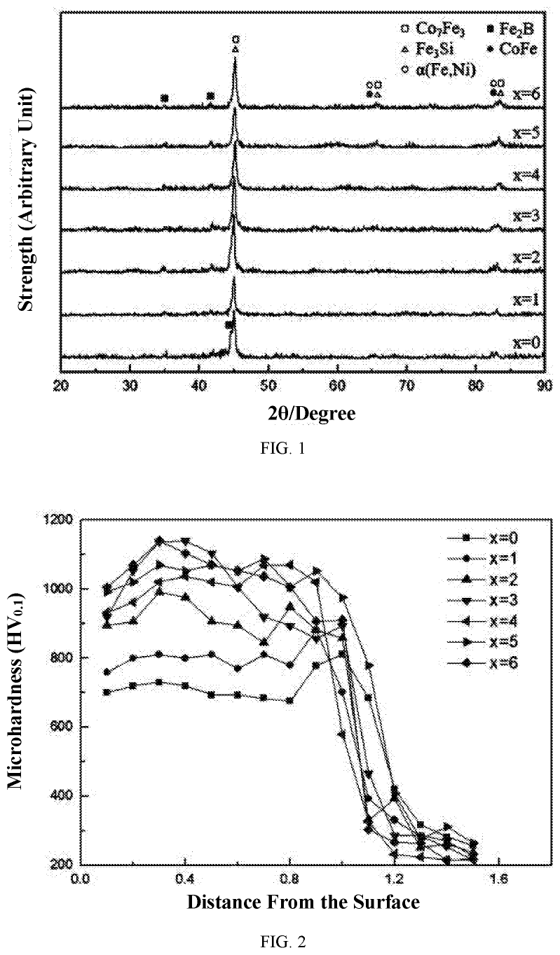

### DETAILED DESCRIPTION OF THE PREFERRED EMBODIMENTS

In order to further explain the content of the invention, the invention will be described in detail hereinafter with reference to the drawings and embodiments.

The invention is based on scientific research experience in the field of laser cladding. Through a large number of experiments, it has been found that the addition of Si element is beneficial to the precipitation of the hard phase of Fe₃Si and increases the hardness of the cladding composite coating; however, excessive addition of Si element will deteriorate the wear resistance and cause abrasive wear during friction and wear. In the invention, a Fe-based alloy component ((Fe_{0.6}Co_{0.2}Ni_{0.2})_{0.75}B_{0.2}Si_{0.05})₉₆Nb₄ with high amorphous forming ability and high strength is selected, and the content of Si element is optimized on the basis.

Unless otherwise specified, “%” in the application document is a mass percentage. Unless otherwise specified, other materials and raw materials used in the present invention are conventional raw materials that can be purchased from the market. The equipment used is also conventional equipment in the art. The operations not mentioned in the invention are all conventional operations in the art.

### Embodiment 1

An iron-based amorphous nanocrystalline laser cladding composite coating, wherein the composition of the cladding composite coating meets the molecular formula ((Fe_{0.6}Co_{0.2}Ni_{0.2})_{0.75}B_{0.2}Si_{0.05})₉₆Nb₄, which has high strength and high wear resistance; the structure is an amorphous nanocrystalline composite structure; the amorphous volume fraction is 21.4%, the particle size of the nanocrystalline is 17 nm, the micro-Vickers hardness is 720 HV_{0.1}, the wear resistance is 11 times that of the conventional 45# steel, and the breaking strength is 2160 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.75}B_{0.2}Si_{0.05})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

### Embodiment 2

An iron-based amorphous nanocrystalline laser cladding composite coating, wherein the composition of the cladding composite coating meets the molecular formula ((Fe_{0.6}Co_{0.2}Ni_{0.2})_{0.72}B_{0.2}Si_{0.08})₉₆Nb₄, which has high strength and high wear resistance; the structure is an amorphous nanocrystalline composite structure; the amorphous volume fraction is 25.5%, the particle size of the nanocrystalline is 20 nm, the micro-Vickers hardness is 791 HV_{0.1}, the wear resistance is 15 times that of the conventional 45# steel, and the breaking strength is 2428 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.72}B_{0.2}Si_{0.08})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

### Embodiment 3

An iron-based amorphous nanocrystalline laser cladding composite coating, wherein the composition of the cladding composite coating meets the molecular formula ((Fe_{0.6}Co_{0.2}Ni_{0.2})_{0.69}B_{0.2}Si_{0.11})₉₆Nb₄, which has high strength and high wear resistance; the structure is an amorphous nanocrystalline composite structure; the amorphous volume fraction is 41.9%, the particle size of the nanocrystalline is 17 nm, the micro-Vickers hardness is 918 HV_{0.1}, the wear resistance is 19 times that of the conventional 45# steel, and the breaking strength is 2880 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.69}B_{0.2}Si_{0.11})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

### Embodiment 4

An iron-based amorphous nanocrystalline laser cladding composite coating, wherein the composition of the cladding composite coating meets the molecular formula ((Fe_{0.6}Co_{0.2}Ni_{0.2})_{0.66}B_{0.2}Si_{0.14})₉₆Nb₄, which has high strength and high wear resistance; the structure is an amorphous nanocrystalline composite structure; the amorphous volume fraction is 25.2%, the particle size of the nanocrystalline is 17 nm, the micro-Vickers hardness is 980 HV_{0.1}, the wear resistance is 15 times that of the conventional 45# steel, and the breaking strength is 2596 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.66}B_{0.2}Si_{0.14})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

### Embodiment 5

An iron-based amorphous nanocrystalline laser cladding composite coating, wherein the composition of the cladding composite coating meets the molecular formula ((Fe_{0.6}Co_{0.2}Ni_{0.2})_{0.63}B_{0.2}Si_{0.17})₉₆Nb₄, which has high strength and high wear resistance; the structure is an amorphous nanocrystalline composite structure; the amorphous volume fraction is 18.5%, the particle size of the nanocrystalline is 18 nm, the micro-Vickers hardness is 1012 HV_{0.1}, the wear resistance is 15 times that of the conventional 45# steel, and the breaking strength is 2354 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.63}B_{0.2}Si_{0.17})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

### Embodiment 6

An iron-based amorphous nanocrystalline laser cladding composite coating, wherein the composition of the cladding composite coating meets the molecular formula ((Fe_{0.6}Co_{0.2}Ni_{0.2})_{0.6}B_{0.2}Si_{0.2})₉₆Nb₄, which has high strength and high wear resistance; the structure is an amorphous nanocrystalline composite structure; the amorphous volume fraction is 14.5%, the particle size of the nanocrystalline is 18 nm, the micro-Vickers hardness is 1024 HV_{0.1}, the wear resistance is 16 times that of the conventional 45# steel, and the breaking strength is 2410 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.6}B_{0.2}Si_{0.2})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

### Embodiment 7

An iron-based amorphous nanocrystalline laser cladding composite coating, wherein the composition of the cladding composite coating meets the molecular formula ((Fe_{0.6}Co_{0.2}Ni_{0.2})_{0.57}B_{0.2}Si_{0.23})₉₆Nb₄, which has high strength and high wear resistance; the structure is an amorphous nanocrystalline composite structure; the amorphous volume fraction is 12.4%, the particle size of the nanocrystalline is 18 nm, the micro-Vickers hardness is 1038 HV_{0.1}, the wear resistance is 17 times that of the conventional 45# steel, and the breaking strength is 2171 MPa.

A preparation method of the iron-based amorphous nanocrystalline laser cladding composite coating, comprising the following steps:

1. weighing the raw materials according to the atomic percentage in the molecular formula ((Fe_{0.6}Co_{0.2}Ni_{0.2})_{0.57}B_{0.2}Si_{0.23})₉₆Nb₄ of the cladding composite coating: pure iron powder (with a content of Fe greater than 99.9 wt %), cobalt iron powder (with a content of Co greater than 99.9 wt %), nickel iron powder (with a content of Ni greater than 99.9 wt %), boron iron powder (with a content of B of 19.4 wt %, the balance is Fe), ferrosilicon powder (with a content of Si of 75 wt %, the balance is Fe), and ferroniobium powder (with a content of Nb of 70 wt %, the balance is Fe), and the particle size of each raw material powder is 100 to 150 μm; then placing the raw materials into a ball mill for ball milling and mixing; the ball milling speed is 120 r/min, and the ball milling time is 12 hrs; mixing the raw materials uniformly to obtain the alloy powder;

2. selecting the national standard q235 low carbon steel with a size of 10 mm×100 mm×100 mm as the base material, polishing the surface with an angle grinder and sandpaper to remove rust, and cleaning the surface with acetone to remove grease to make the surface clean and flat;

3. drying the alloy powder in a drying box at a temperature of 80° C. for 4 hrs, and placing the steel substrate in the drying box to dry at a temperature of 80° C. for 30 mins; then tiling the alloy powder on the surface of the steel substrate, and the thickness of the alloy powder tiled is 1 mm;

4. adjusting the distance from the mirror surface of the 3 kW semiconductor laser to the surface of the substrate to a focusing distance of 310 to 320 mm; an infrared pre-scan is used to determine an area to be cladding;

5. adjusting the parameters of the laser cladding process: setting a laser power of 2 to 2.5 kW, a laser scanning speed of 5 to 6 mm/s, and a spot size of 14.5×2.5 mm; the laser beam is scanned vertically; performing the laser cladding on the preset alloy powder to obtain the iron-based amorphous nanocrystalline laser cladding composite coating.

A test method of the iron-based amorphous nanocrystalline laser cladding composite coating, which is used to test the breaking strength of the cladding composite coating, comprising the following steps:

1. removing the cladding composite coating and part of the substrate by wire cutting, then removing the substrate by sandpaper and polishing the cladding composite coating to the middle; preparing the middle of the cladding layer into a rectangular parallelepiped sample with a length of 0.5 mm, a width of 0.5 mm, and a height of 1 mm, and ensuring the opposite sides of the rectangular parallelepiped sample to be parallel;

2. placing the sample vertically on the compression table of a universal testing machine at room temperature, and setting the compression rate as 5×10⁻⁴ s⁻¹;

3. compressing the sample to obtain the stress-strain curve until the sample breaks.

The property tests of the iron-based amorphous nanocrystalline laser cladding composite coatings of Embodiments 1 to 7 are performed, and the results are as follows:

The XRD pattern of the Fe-based cladding coating was measured using a D8Advance polycrystalline ray diffractometer (as shown in FIG. 2); it can be seen from FIG. 2 that with the increase of the content of Si element, the amorphous volume fraction of the cladding coating first increases and then decreases.

Jade software is used for simulation; the cladding coating prepared in Embodiment 3 has the highest amorphous volume fraction of 40.9%.

The Scherrer Formula can be used through XRD diffraction peak full width at half maximum to calculate the nanocrystalline particle size of the cladding coatings in Embodiments 1 to 7 from 17 to 20 nm (The Scherrer Formula is:

$$D = \frac{K λ}{B cos θ} ;$$

wherein D refers to the particle size, K refers to the Scherrer constant, and generally K is equal to 0.89, λ refers to the wavelength of X-rays (0.154056 nm), B refers to the full width at half maximum (Rad) of the diffraction peak of the test sample, and θ refers to the diffraction angle (Rad)).

TABLE 1
Full Width at Half Maximum of Diffraction Peaks and
Nanocrystalline Particle Sizes in XRD Patterns
of Cladding Coatings in Embodiments 1 to 7

| Embodiment | Full Width at Half | Nanocrystalline |
|---|---|---|
| Number | Maximum (°) | Particle Size (nm) |
| Embodiment 1 | 0.514 | 17 |
| Embodiment 2 | 0.431 | 20 |
| Embodiment 3 | 0.506 | 17 |
| Embodiment 4 | 0.492 | 17 |
| Embodiment 5 | 0.488 | 18 |
| Embodiment 6 | 0.472 | 18 |
| Embodiment 7 | 0.485 | 18 |

The above Fe-based cladding coating is subjected to wire cutting, its cross-section is sanded and polished, and the cladding coating and the cladding coating-substrate interface are tested for hardness to obtain micro-Vickers hardness; FIG. 2 is the hardness distribution of the microhardness of the cladding coating from the surface of the cladding coating to the interface in Embodiments 1 to 7; it can be seen from the diagram that the micro-Vickers hardness of the cladding coating prepared in Embodiment 7 is the highest, reaching 1120 HV in the middle of the cladding coating, and the average micro-Vickers hardness is 1038 HV.

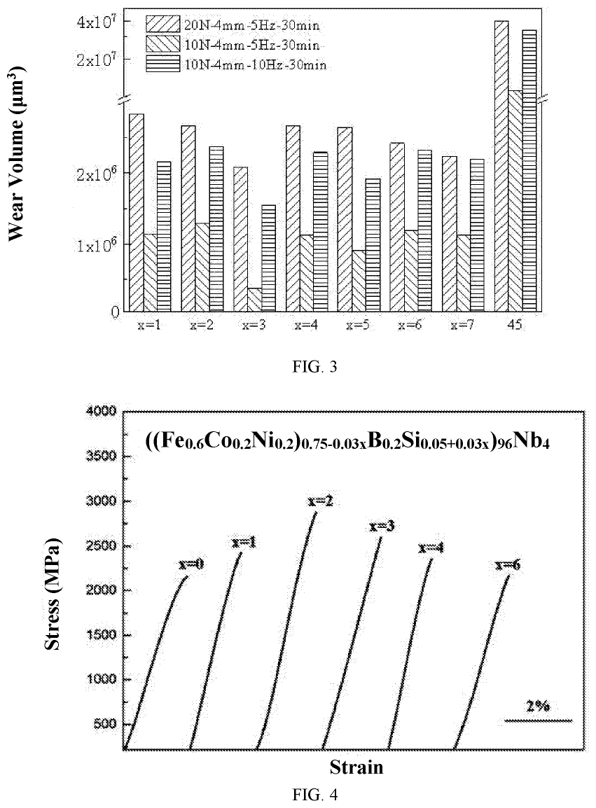

After the cladding coatings prepared in Embodiments 1 to 7 and the surface of 45# steel were polished with 1000-mesh sandpaper, the friction wear test was performed respectively with a load of 20 mN, friction distance of −4 mm, friction frequency of −5 Hz, a load of 10 mN, friction distance of −4 mm, friction frequency of −5 Hz, and a load of 10 mN, friction distance of −4 mm, friction frequency of −10 Hz, and a friction wear time of 30 mins, the results are shown in FIG. 3: the addition of a certain content of Si element improves the wear resistance of the cladding coating; the cladding coating prepared in Embodiment 3 has the best wear resistance, the wear volume is the lowest under three conditions of friction and wear (different loads and different friction frequencies), and the wear resistance is 19 times that of the conventional 45# steel.

The breaking strength of the cladding coatings prepared in Embodiments 1 to 7 is shown in FIG. 4; the addition of a certain content of Si element can improve the breaking strength of the cladding coating; the breaking strength of the cladding coating prepared in Embodiment 3 is up to 2880 MPa, and the yield strength of 235 MPa is greatly improved compared to q235 substrate, which is more than ten times that.

Although the invention has been described in detail with the general description and specific embodiments hereinabove, it is obvious to those skilled in the art that some modifications or improvements can be made based on the invention. Therefore, modifications or improvements made without departing from the spirit of the invention shall all fall within the protection scope of the invention.

1. An iron-based amorphous nanocrystalline laser cladding composite coating, wherein the composition of the cladding composite coating meets the molecular formula: FeaCobNicBdSiyNbe, where a, b, c, d, y, and e respectively represent the atomic percentage of the corresponding alloy element; a is greater than or equal to 32 and less than or equal to 44, b is greater than or equal to 10 and less than or equal to 15, c is greater than or equal to 10 and less than or equal to 15, d is greater than or equal to 18 and less than or equal to 20, y is greater than or equal to 4 and less than or equal to 23, e is greater than or equal to 4 and less than or equal to 5, and a plus b plus c plus d plus y plus e equals 100.

2. The iron-based amorphous nanocrystalline laser cladding composite coating according to claim 1, wherein the atomic percentage of Si element in the molecular formula is preferably that y is greater than or equal to 4.8 and less than or equal to 22.08, and a plus b plus c is greater than or equal to 55 and less than or equal to 72.

3. The iron-based amorphous nanocrystalline laser cladding composite coating according to claim 1, wherein the structure of the cladding composite coating is an amorphous nanocrystalline composite structure, and the maximum amorphous volume fraction is 12.4% to 40.9%, and the particle size of the nanocrystalline is 17 to 20 nm.

4. The iron-based amorphous nanocrystalline laser cladding composite coating according to claim 2, wherein the structure of the cladding composite coating is an amorphous nanocrystalline composite structure, and the maximum amorphous volume fraction is 12.4% to 40.9%, and the particle size of the nanocrystalline is 17 to 20 nm.

5. The iron-based amorphous nanocrystalline laser cladding composite coating according to claim 1, wherein the micro-Vickers hardness of the cladding composite coating is 720 to 1038 HV_{0.1}; the wear resistance is more than 11 times that of the conventional 45# steel, and the breaking strength is 2160 to 2880 MPa.

6. The iron-based amorphous nanocrystalline laser cladding composite coating according to claim 2, wherein the micro-Vickers hardness of the cladding composite coating is 720 to 1038 HV_{0.1}; the wear resistance is more than 11 times that of the conventional 45# steel, and the breaking strength is 2160 to 2880 MPa.

7. A preparation method of the iron-based amorphous nanocrystalline laser cladding composite coating according to claims 1-6, wherein the preparation method comprises the following steps:
step 1: weighing the raw materials according to the atomic percentage in the molecular formula FeaCobNicBdSiyNbe of the cladding composite coating: cobalt iron powder, nickel iron powder, boron iron powder, ferrosilicon powder, ferroniobium powder and pure iron powder, and mixing the raw materials uniformly to obtain the alloy powder;
step 2: polishing the surface of the steel substrate to remove rust and grease to make the surface clean and flat;
step 3: after removing the residual moisture from the alloy powder and the steel substrate, tiling the alloy powder on the surface of the steel substrate;
step 4: adjusting the parameters of the laser cladding process so that the laser beam is scanned vertically; performing the laser cladding on the preset alloy powder to obtain the iron-based amorphous nanocrystalline laser cladding composite coating.

8. The preparation method of the iron-based amorphous nanocrystalline laser cladding composite coating according to claim 7, wherein the raw materials in step 1 are: Fe is the pure iron powder with a content of greater than 99.9 wt %, Co is the cobalt iron powder with a content of greater than 99.9 wt %, Ni is the nickel iron powder with a content of greater than 99.9 wt %, B is the boron iron powder with a content of greater than 19.4 wt %, Si is the ferrosilicon powder with a content of greater than 75 wt %, and Nb is the ferroniobium powder with a content of greater than 70 wt %; the balance in the cobalt iron powder, nickel iron powder, boron iron powder, ferrosilicon powder, ferroniobium powder is Fe, and the particle size of each raw material powder is 100 to 150 μm.

9. The preparation method of the iron-based amorphous nanocrystalline laser cladding composite coating according to claim 7, wherein the method of mixing the raw materials in step 1 is to use a ball mill for ball milling and mixing; the ball milling speed is 100 to 120 r/min, and the ball milling time is 10 to 12 hrs; the method of removing the residual moisture from the alloy powder and the steel substrate in step 3 refers to drying the alloy powder in a drying box at a temperature of 80 to 100° C. for 4 to 5 hrs, and placing the steel substrate in the drying box to dry at a temperature of 80 to 100° C. for 30 to 40 mins.

10. The preparation method of the iron-based amorphous nanocrystalline laser cladding composite coating according to claim 7, wherein in the method of tiling the alloy powder on the surface of the steel substrate in step 3, the thickness of the alloy powder tiled is 0.9 to 1 mm;
in the method of adjusting the parameters of the laser cladding process in step 4, the specific parameters are a laser power of 2 to 2.5 kW and a laser scanning speed of 5 to 6 mm/s.

11. A test method of the iron-based amorphous nanocrystalline laser cladding composite coating according to claims 1-6, wherein the method is used to test the breaking strength of the cladding composite coating, comprising the following steps:
1) separating the iron-based amorphous nanocrystalline laser cladding composite coating from the iron-base, to obtain a sample of the amorphous nanocrystalline laser cladding composite coating;
2) placing the sample vertically on the compression table of a universal testing machine at room temperature, and setting the compression rate;
3) compressing the sample to obtain the stress-strain curve until the sample breaks.

12. The test method of the iron-based amorphous nanocrystalline laser cladding composite coating according to claim 11, wherein the sample of the amorphous nanocrystalline laser cladding composite is a rectangular parallelepiped with a length and a width of 0.5 to 1 mm and a height of 1 to 2 mm; the compression rate is 4×10⁻⁴ s⁻¹ to 5×10⁴ s⁻¹.
